(19) United States
(12) Patent Application Publication
(10) Pub. No.: US 2017/0068910 A1
(43) Pub. Date: Mar. 9, 2017

(54) SYSTEM AND METHOD FOR MUSIC DISTRIBUTION

(71) Applicant: Alex Burroughs, San Diego, CA (US)

(72) Inventor: Alex Burroughs, San Diego, CA (US)

(21) Appl. No.: 15/355,811

(22) Filed: Nov. 18, 2016

Related U.S. Application Data
(63) Continuation-in-part of application No. 14/132,644, filed on Dec. 18, 2013, now abandoned.

(51) Int. Cl. G06Q 10/02; G06Q 30/06

(52) U.S. Cl. CPC G06Q 10/02; G06Q 30/0601

(57) ABSTRACT

A system for rewarding a legal purchase of music or live performance tickets by users is provided which allows communication over a network for user registration and sales of digital music and live performance tickets. Users legally purchasing music or live performance tickets to performances at venues of the system provider are given digital downloads of performers' music, discounts to merchandise related to the artist or musical group producing the digital music or live performance. The system provider can also encourage performers to appear at venues by paying them for appearing based on user preferences.

This application is a Continuation-in-Part application to U.S. patent application Ser. No. 14/132644 filed on Dec. 18, 2013, which is incorporated herein in its entirety by this reference thereto.

### BACKGROUND OF THE INVENTION

1. Field of the Invention

The present invention relates to music-based social networking services. More specifically, the invention relates to a software enabled method for providing incentives to fans for the legal purchasing of artists music, merchandise, and other products and a manner for payment, and concurrently providing an interface for musical artists and groups and payment for their recorded music and live music performances. The invention is employable as an internet-based music provision service in combination with a performing art dual payment service based on both performances and merit.

2. Prior Art

The goal of most musicians and artist alike is to have their music reach the masses, let their message be heard, and of course, make a living through payment for their art. However, it is well known that without proven ability to attract fans for sufficient recording sales, many record companies will not provide adequate compensation to artists. Further, with the advent of the internet and enhanced software and personal computers, it is possible for many recording artists to publish their own music which is sold or distributed directly to buyers and allowing them to skip the production companies.

However, the advent of music digitalization has also had a chilling effect, in more recent years, on the legal purchase of music from electronic retailers along with a reduction in the remuneration to the artists for their creations. Listeners and fans can in fact download music in various file formats from websites which host and download such songs and albums illegally. Such sites and servers are frequently in foreign countries and therefor almost impossible to close or discourage.

In recent years, a number of firms such as APPLE have become predominate distributors of digitized music in the ever more web-connected world. Additionally, music listeners have grown up with digitized music rather than CD or tape-based media carrying music. Additionally, record companies have become less inclined to sign new musical groups to contracts, and newer groups have discovered they can sell directly to consumers and leave the larger record companies out of the loop.

As an unfortunate consequence of the centralization of digital distributors of music, the lower importance of record labels and producers, and direct selling by new musical groups, and the illegal hosting and downloading of music files, many artists have seen a lessening of income from royalties on recordings. Newer groups, as well as long-established musicians, have been considering other methods of increasing or even maintaining revenues. Additionally, fans do not have a feeling of connection with the groups or other fans of the group, but for those that take the time to register as fans on a group-based site. Further, fans of one group may never know of a group with a similar genre of music due to the fragmented nature of digital music on the internet.

In today's modern age, the internet has provided a key roll in allowing almost any artist to expand to a global level and reach fans. With the emergence of social networking services, users from all over the world can connect, chat, and interact with another user in virtually any other location in the world with an internet connection. Recently, more specialized music-based social networking services have arisen to provide an opportunity for musicians and artists to submit their music to the worldwide stage for any and all ears to hear. Some of these sites include SPOTIFY, ITUNES PING, PANDORA, FLOTONES, and REVERBNATION to name a few. These, as well as others, have successfully provided a means to entertain the public by bringing the general fan closer to the music genre or artist they like. However, with the ability to stream music to one's personal computer or smart phone, and the proliferation of illegal downloading, record sales and artist compensation continue to see a decline.

For example, SPOTIFY is a music social networking service wherein advertisers pay the service to run ads. Free users must view ads in order to listen to music while paying users enjoy the service ad free. In order to stream music, SPOTIFY pays record companies to stream their music and in turn, the record companies pay the artists. However, as noted above, the compensation to the artists from the record companies is sparse.

ITUNES PING is another music-based social network wherein users can follow artists through photos and status updates, as well as allowing users to follow their friends and friends music interests. Ping further ties the social network service to the online marketplace wherein users can purchase songs. However, Ping does not provide any incentive to the users to purchase music from their favorite bands or new groups. As a consequence, most users having grown up in a digitized music world, and having no real connection with the groups or music they prefer, have no reason to legally download and pay sites like ITUNES for the music they load to their digital players, especially since they can stream music from other sites for free.

These and other conventional music-based social networking services similarly fall short since there is generally no personal connection with the artist or other fans and no other incentive for users to purchase artist music or merchandise. Thus, artist compensation continues as generally inadequate.

Additionally, now, as in recent decades, many bands travel and perform at small venues such as bars and nightclubs, and the same concerns for artists, bands and fans are at issue where such bands do travel this circuit. For the individual musical artists, as well as musical groups, securing venues in which to play is a first problem. Such performing artists and groups have a second problem in getting paid a contracted amount by each small venue such as a bar or nightclub and selling their recorded music to fans during a venue visit, since they are performing during most of any venue appearance.

As can be imagined, online music selling services provide little to no financial gain to new artists or those with smaller followings and are becoming undesirable to musical groups and artists and related affiliates. Neither do the local small venues provide any manner for performing artists to sell and distribute their music. Further, for artists working in smaller venues getting paid can be a serious concern since they may only be performing one night and move to another venue in another city.

Musicians and artists alike spend countless hours, days, and years, perfecting their craft and producing a final product that their fans deserve. Profits merely continue to be seen by the site owners from advertisements and product placements directed to the fans that the artists themselves are drawing in. The musicians and artists driving the main traffic to these sites have therefor earned, and are due, enhanced financial restitution which these sites do not provide.

Second, conventional online music services lack in the ability to connect fans to other sources of favored-artist networking, such as touring in small venues, concerts, festivals, and artist merchandise, which in turn provide additional revenue for the artist. Although the conventional services may provide a means to promote or advertise upcoming shows, when the average consumer is bombarded with hundreds of ads a day, a simple promotion ad may not successfully engage the fan as the artist would desire.

Still further, in the current art, it can be hard for new performing artists and groups to secure venues for live performances. Those that do are continually having to negotiate payment from each such small venue such as nightclubs, bars, and small concert halls, on a venue specific basis. Even when so negotiated such performing artists and groups are not insured payment from these venues and when on a tight travel schedule, they may not have the luxury of being present the following day to secure payment.

Further, in all venues where multiple performing artists and musical groups perform, there will be one or more of the performers who drive the paying fans to the venue. Others in the plurality of artists performing may be new to fans and not as responsible for the size of the crowd, but still entitled to payment for services. The current system provides no insurance for payment, nor does it allow for both merit payment to artists who attract the most fans to a venue, in combination with revenue sharing with the newer performing artists who might not have such a following.

As such, there is a continuing unmet need for an improved business method and service to provide a means for artists and musicians alike to effectively bring their product to the masses while additionally insuring that the artists themselves, receive reasonable financial restitution for their creations and their performances. Such a method should be easily used and advantageously will be employable through conventional media such as web-based social networking. Such a method should provide users a reason to visit a music website and pay for legal downloading of music files. Such a web based business should also endeavor to encourage visitation to musical artist performance venues through the socializing of like-minded music fans with each other, and by exposing such visitors to new groups which will further increase sales.

Additionally, such a system and method should ideally provide rewards for user payment to addend an artist's live show or concert, and/or for legally purchasing the artist's albums. Finally, such a system, in addition to informing users of performances by favored and new musical artists and bands at smaller venues, should additionally provide a conduit for paying those musical artists for their respective performances to insure those performing at small venues such as nightclubs and small concert halls, are paid. In making such payments, such a system should ensure both merit payments and share payments to the respective performing artists at the venue.

### SUMMARY OF THE INVENTION

The device and method herein disclosed and described provides a solution to the shortcomings in prior art of digitized music distribution and achieves the above noted goals through the provision of a network-based business system for selling and distributing musical files in conjunction with a music-based social networking service and rewards system to users legally purchasing music or paying for tickets allowing attendance at performances and concerts.

The method provides a user friendly service that aims to solve many of the problems associated with music sales and the music industry by encouraging users to legally purchase tickets for artist performances and music online with the provision of discounts to visit music festivals and concerts and for the purchase music related merchandise. Alternatively, the system can reward fans who pay to attend a concert with free or discounted purchases of artist merchandise and artist albums to encourage legal purchases.

Still further, the system herein can function concurrently, as a conduit for paying musical artists and groups, for their local performances at small venues such as nightclubs, bars, and smaller concert halls. Such will encourage up and coming artists to play smaller venues and travel to such to generate fans.

By providing user fans the ability to purchase tickets to attend performances at smaller venues, and also providing a time-limited download of digital music files related to a each respective musical group or artist after such a performance, the system will help new musical groups and artists get paid for their services on a merit basis by enhancing the payment to those driving the crowd to the venue. Further, the system will help newer or lesser known artists to develop a fan following by also providing a digital file download of artist music for a determined time after the doors to a performance open at a small venue, and by paying a share of revenue to the newer artists.

Further, through the provision of social networking of like-minded individuals, a spirit of comradery is also provided thereby encouraging use of the website. This combination is a means to provide users a reason to purchase an artist's or musical group's music or attend their concerts, and guaranteed payment to the artists, thereby resulting in an enhanced revenue stream to the artists. Such can also generate increased revenues to the artist's producers and record labels which concurrently will encourage new artists and the entire industry to expand.

As a brief note, although the disclosed method is preferably employed through a web-based online service, such as a social networking service, one skilled in the art may immediately recognize that the steps and practices set forth in this disclosure may similarly be employed through other conventional service methods without departing from the overall scope and intent of the invention as will become apparent upon further disclosure, and is anticipated. Further, the disclosed system and method herein, could easily be adapted into conventionally existing music sales sites and such is anticipated to be within the scope of this application.

The system herein, through the provision of an internet based service via an online service provider, provides users the ability to access a communicated graphic interface or webpage, wherein the user can then register an account. Thereafter, in addition to the ability to legally download or purchase music, and to purchase concert or performance tickets, the system provides the registered user with means for social networking with friends and increased attendance at smaller venues during scheduled time frames of the performances of the musical artists.

In operation in one mode, users, by searching for the desired artists, and registering with the site can include their interest in particular new or established musical artists and may then be provided with news and updates regarding the artists' music, photos, concert touring dates, merchandise, etc., essentially connecting the user directly to the artists. Still further, for a determined time period users can download digital music files or stream artists' music for instant listening or similarly create playlists for continuous listening. When streaming music, as well as browsing artists, advertisers will be provided with a means to present visual and audio advertisements wherein compensation to the service, record companies, and artists is provided in a conventional manner.

In all modes of the system herein users are provided the ability to purchase tickets to upcoming performances at large venues and in particular smaller venues where newer musical artists and groups may be preforming. Users are further provided with online means to purchase artists' music, albums, merchandise, and other products.

Further, in one particularly preferred mode of the system, users are allowed to download a digital music file of the album of an artist or musical group for which they have purchased performance tickets. This download is allowed for a specific determined time period starting at the a start time for the subject performance. The time period for downloading for a limited or determined period, subsequent to the start of the performance for which the user purchased tickets, also serves to determine a rating for a first payment of a revenue share to each performer based on merit as an artist percentage, based on ticketed users who downloaded each performer's digital music or media file.

As an advantage over prior art of digital music sales, the invention includes the novel action of providing such incentives for the user to purchase the artists' products and/or for attending the artist's live performance. These incentives are controlled by the site and the artists, and can include discounts on merchandise, discounted future concert tickets, a free download of an artist's recorded music, and even free concert tickets. Because illegal sites for music will lack these artist-related and approved incentives, such incentives will urge users to attend the artist's live performances and/or purchase artists' albums legally, and will enhance the artists' revenues through increased album sales and merchandise sales.

Such inducements, which require artist approval or participation, as noted, would be unavailable on illegal music sites since the artists would never participate at such venues. The inducements to fans and purchases can be discounted or free tickets for the users/fans to attend concerts, festivals, and shows where their favorite artists will be performing. In the alternative, fans who pay to attend a live performance or concert, can be given discounts to purchase the digital album and merchandise, or in a particularly preferred mode of the system, paying users to a performance, are allowed to download a digital music file of the performing artist for a limited time following the performance. In addition or in place of free tickets, discounts on artist-related merchandise such as posters, clothing and the like can be provided to the fans and buyers. Such inducements being unavailable on pirate sites, will surely encourage actual purchase of music on the site herein and attendance at an artist's live performances.

Additionally, the method herein may allow for advertisers with further advertising means to communicate ads to fans and buyers. This can be through discounts and coupons for products of advertisers related to or sponsoring concerts and tours, or at the festivals and concerts to which music buyers receive admittance or discounted tickets. This increase of exposure to the advertiser aids in maintaining adequate revenue streams for the advertisers and affiliates, providing another means for solving many of the problems noted above.

Still further, and in a particularly preferred mode of the system, it will function as a conduit to pay musical artists and musical groups for their performances at local venues which are attended by ticket-purchasing users of the system. In this mode of the system, the system provider will sell tickets to users or attendees to attend a performance at a venue, such as a bar or nightclub, or concert hall or theater. There may be more than one musician or musical group performing at such a venue on a performance date.

To encourage new artists and musical groups to make such performances, at smaller venues which are notorious for failing to pay the artists a contracted amount, the system will electronically pay each artist or group subsequent to a performance. To encourage attendance, the system will sell tickets to users which also allow each ticket purchaser the right to download one digital music file of the artist of their choice who is performing at the venue, for a limited time duration of subsequent to a start time of any concert or performance. Where multiple groups are performing at a single venue, the user ticket purchaser can choose to download the digital music file of one of the artists or groups who performed. Additionally, the system can sell artist or musical group merchandise to suers.

By handling ticket sales and artist payment, the system herein encourages smaller groups and new artists to publicly perform by insuring they will be paid a share of revenues. By revenues is meant the total amount collected from ticket sales and/or other sales relating to an event on a date at a venue, minus any costs or any profit share of such revenues to the system provider.

Further, by paying the artists and groups to perform, the system herein will help provide a wider selection of venues for such performances by rendering them essentially free to the nightclub, bar for example providing the venue. The nightclub or bar will have significantly increased sales of food and drink from the crowds and be relieved of paying the performers and having to negotiate such payment.

Using the system herein, new artists and musical groups with smaller followings, will have a much larger opportunity to perform through a wider availability of venues from bars and nightclubs and the like, who profit by their performance without having to pay them. Further, by allowing users to download a single digital file of an album of one group or artist performing, for a time limited time duration subsequent to a performance start time, users are encouraged to attend concerts and the like and see a favored artist or group, and new artists and groups.

A determination of current and rising popularity of an artist or musical group is thereafter easily ascertained by tabulating the number of users who choose to download a digital file of a respective group or artist's music. Such can be a significant factor for a new group or artist getting a recording deal from a large recording company. This step in the system also allows for a first payment to each of the plurality of performers at a venue based on an artist percentage based on their respective digital file downloads, and a second equal share payment to each of the performers from a remainder of the revenues after the first payment.

Finally, in another mode of the system herein, the system will provide users a feature that helps connect users who play music, such as new bands, to find other musicians. For example, a first user may be a guitar player or a number of players, who need a drummer to accompany them in the San Diego region. Further they may require a drummer with a certain experience, age, musical interest, etc. Using the system, users in search of another musician, can search using a library of musician users who also have specifics about their musical talents and interests stored with the service provider. In the case of the drummer for instance, the drummer user, once they complete their profile, musical interest and experience profile, can upload soundtracks that users seeking fellow musicians can listen to and discern a musical nexus. The looking user can then get in contact with that user drummer to arrange for a group session and perhaps form a musical band. So therefore, not only does the system herein change the way users may listen, share, see, purchase, and connect to music and related merchandise, but the system may be employed to aid in creating new music and musical groups by providing a means for musicians to find like minded and creative users to work with.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of the invention to provide a business method which connects fans, artists, advertisers, and record companies in a social network.

It is a further object of the system herein, to encourage new and established musical artists and musical groups to perform at local and distant venues, through the provision of a payment system to the musical artists, and a ticketing system to the users for such performances.

It is another object of the invention to provide a business method that adequately solves the financial needs of artists, record companies, advertisers, and affiliates which has been conventionally lacking in the music industry.

It is yet another object of the invention to provide incentives to users/fans to legally purchase artists' music, albums, and merchandise in return for discounted or free concert tickets or merchandise discounts.

It is a further object of this invention to provide incentives to users and fans who attend an artist's live performance which will also encourage legal downloading and/or purchases of digital recordings of a favored group or artist.

It is still anther object of the invention to create and promote artists' tours, festivals, and concerts, and to provide a means to ascertain rising fan interest by tracking digital music related to groups or artists downloaded by concert attendees within a limited amount of time subsequent to a performance.

It is a still further object of this invention to provide a means for musicians to find fellow musicians with whom to create and play music.

It is yet another object of this invention to provide a system which pays performing artists and groups based on both merit and simple performance at a venue.

### BRIEF DESCRIPTION OF DRAWING FIGURES

FIG. 1 shows a flow chart of the invention for providing incentives for legally purchasing music and associating like users.

FIG. 2 depicts a mode of the system with rewards provided to attendees of live performances in the form of discounts for recorded music and other goods.

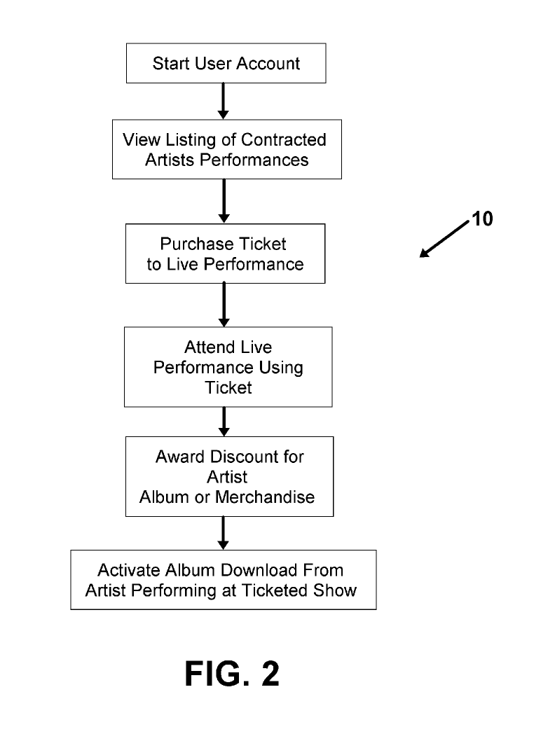

FIG. 3 depicts a mode of the system herein, wherein the system provider pays artists and musical groups for performances at venues owned by third parties, based on ticket revenues which are divided to the performing artists based on subsequently downloaded digital music files of the performing artists.

FIG. 4 depicts a mode of the system similar to FIG. 3, where ticket sales revenue is paid to the performing artists based upon which digital music files are downloaded by attendees of the show or concert, but also allowing non registered user attendees to purchase tickets first and become registered users subsequently.

### DETAILED DESCRIPTION OF THE PREFERRED EMBODIMENTS OF THE INVENTION

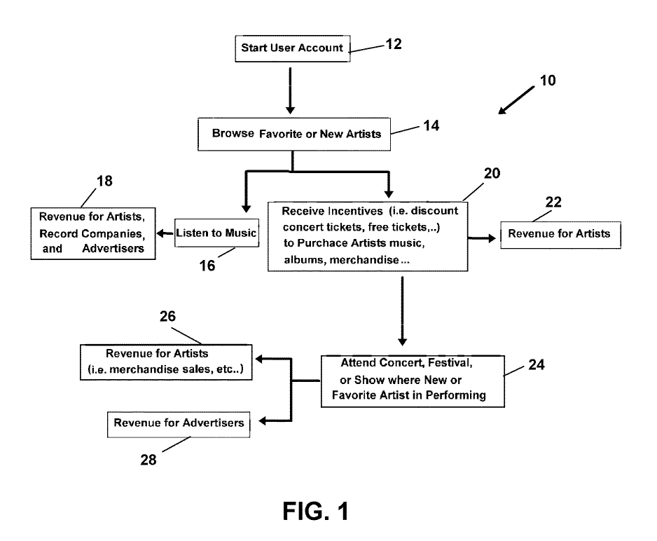

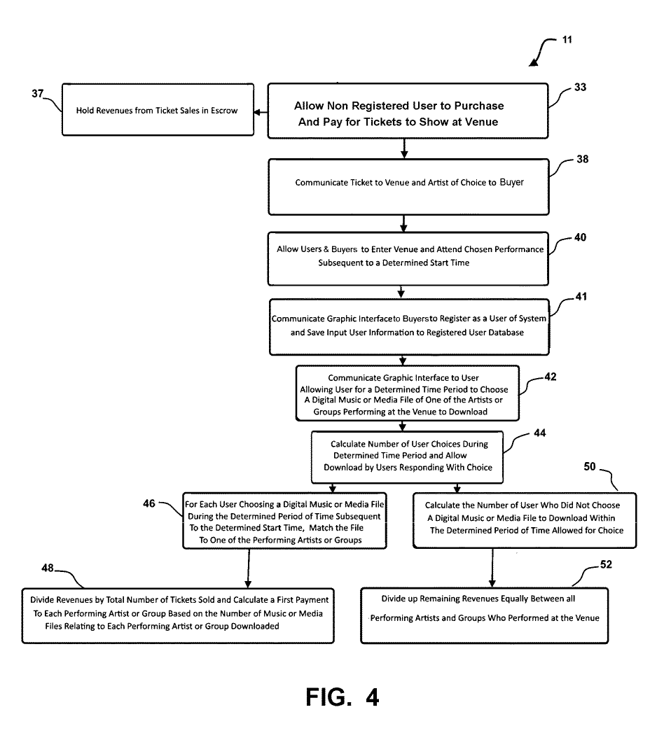

Now referring to the drawings in FIGS. 1 and 4, wherein similar components are identified by like reference numerals, there is seen in FIG. 1 a simplified flow chart of one mode of the system herein, which like all other modes employs software configured to the task of enabling and operating the steps of the method herein, and implementing the system on the computing system of the system provider of the present invention.

Through the disclosed web-based method, using software running in electronic memory of a network-connected computing device, such as a computer or server, which is configured to the task of creating user profiles through the communication of a graphic sign-up interface to the screens of new users, a subscribing user is first provided with a means to set up an account 12 with the service provided by the disclosed system herein. It is particularly preferred that the service account 12 is set up through communication of a graphic interface via an online based web service or website. However, in yet other preferred modes of the system, a user may sign up or register through a graphic sign up interface communicated to a video display positioned at a booth or other type service at a concert venue, street fair, etc, or through televison ad services for example.

In all preferred modes of the system herein, advertisers may be provided with means for direct advertising to the users such as through ad space at the particular booth, or displayed on the depicted graphic interface webpage of the service or through the provision of discounts on advertisers merchandise which encourage legally purchasing music. Such ads and discounts will be subsequently communicated to graphic interface pages communicated to users based on their input personal profile, and their record of purchases using a relational database which tracks their music and musical group affinity.

It must be noted that although it is preferred that the disclosed business method is employed as a networked or web-based service, those skilled in the art will recognize various other means of employment without departing from the overall scope and intent of the invention. Such might be for network or internet connected computers having electronic memory and video displays located at sign up kiosks located in malls or at festivals. As such, the following description while referring in the most part to an online service communicating with the computer and video display of a user, such as a smartphone, pad computer, laptop, or desktop, should not be considered limiting in that manner.

In accordance with the mode of the method employing a networked, internet or web based services, users will register their personal profile upon communicated graphic interfaces for such and form an account, using software configured to the task and communicated to users from the service provider server.

Subsequently, the users will be provided with a means of encouragement for legally purchasing digital music files of artists performances, through the provision of a social networking service related to artists of interest and music of interest.

From the user's sign up session and their created user profile from using communicated graphic sign up interfaces, and using a relational database to associate users answering profile questions that show a relation to a particular music genre or group, users will be provided with access initially to groups of other users shown to have related music or group affinity. Such a social network may be provided for user sharing of discussions about favorite groups and artists, finding friends or finding like-minded friends interested in the same artists, sharing photos and videos, posting updates, and chatting with friends.

Further, it is of particular preference that the user, herein also referred to as a ‘fan’, can be provided with graphic interface screens allowing them to search for their favorite artists 14, genres of music, browse new and upcoming artists, browse the artists their friends are listening to, and similarly receive news updates or ‘feeds’ about their favorite artists or music in question.

Using this assembled initial user profile held in electronic memory of the system provider, and the input from the user cross referenced with the relational database of users and groups and music, and user searches using communicated graphic interfaces for searching, and voluntary inclusion inputs by the user, the user or fan is thus provided with an instant connection to the artists they enjoy and can maintain a virtual one-on-one connection with them thereby drawing them to the site where music is legally sold.

Further, employing software from the server or networked computing system of the system provider configured to the task of using ascertained legal digital copies of music owned by or purchased by the user, the user can create and share playlists of musical artist songs or albums for instant listening 16. In one favored mode, users may “broadcast” a play list and can simulate a radio DJ, advertising the play list through messages and transmissions on the social networking portion of the site. During the “streaming” of music from the aforementioned playlists, the user may have an account with the service provider for the system and using coupon or paid money-credits, can pay the service provider royalties if required for the streaming of music and the service pays record companies to stream their music and in turn the record companies pay the artists.

In another favored mode of the system, advertisers are provided with means for audio advertising between, before, or after songs for example. Many advertisers sponsor concerts and tours of various artists and the system herein provides the ability for such advertisers to gain individual users of the system as customers. The artists would be provided revenue from one or both of the record companies and the advertisers, and as such, in this action of the business method, the artists, record companies, and advertisers are provided with a user-encouraged source of revenue 18.

Artists and music genre information including news updates, concert schedules, etc. are provided via specific web pages and links thereto on the system which are tailored to that artist or genre. By visiting these pages, or similarly opting to receive regular occurrences of information, users or fans are provided with encouragement to use the site and pay for music therefrom by the ability to stay up to date with news, biographies, videos, music, and merchandise about the artists in order to maintain a connection as such.

Further, employing the social networking side of the system, users can communicate electronic messages to like minded friends that they are attending an upcoming concert and similarly see if their friends are attending in order to stay socially connected to them. Furthermore, when visiting these pages or indicating attendance to a certain concert or show, the user may be prompted with notices showing similar or comparable artists that the user may also enjoy. This allows many unfamiliar artists to be noticed when up against popular artists of similar taste, thereby encouraging expansion of musical artists.

As a particularly preferred action of a mode of the system herein to encourage legal purchases, when users legally purchase an album or digital songs of a musical group, and/or purchase a concert ticket for a group through the service provider, the user will be provided coupons or deal codes or coupon codes or the like which are good for one or a plurality of incentives to legally purchase the same artists' merchandise 20. Merchandise can primarily include a group of merchandise items including albums, individual songs, apparel, accessories, and more. Thus, legal music purchases of the music or performances of a group of musical artist, are rewarded as are legal attendance at concerts.

In another mode, it is preferred that the incentive to buy merchandise 20 is also an incentive to legally buy digital music by providing a discount using a provided code or coupon identifier for discounted or free concert tickets to the user's favorite artists, or alternatively may be discount codes or coupons for discounts on other merchandise and so forth, depending on the total sale amount. These incentives for merchandise or concerts for legal music purchases will draw in further revenue for artists 22 as conventional merchandise sales have continued to drop due to the provision of current online digital music sales. The same incentives for legal purchase of digital music of an artist or musical group chosen by a user, can also be given for purchases of concert tickets for the chosen group or performer. In this case the discount codes provided would of course be for merchandise, and for a discount on a digital music purchase. This of course also encourages the legal purchase of digital music of an individual artist or musical group, by rewarding legal attendance at concerts of the same artist or musical group.

When the user receives the digital music as a digital file, or a concert ticket in the mail or email, or in the case of a digital sale, completes a download of a digital file playable to hear and/or see the chosen artist or group, concurrently communicated to the user will be a means to receive or use the incentive noted above for the same artist or musical group. This can include an activation code, coupon code, discount code, or a physical coupon or the like. This code can then be entered through the server of the service provider using software configured to the task of input of discount identifiers and applying them to the appropriate product, to provide the user with the free or discounted concert/festival/show ticket.

It is of yet another preference that the concert or festival or show for which discounts are given for legal music purchases of an artist or musical group, is provided via artist touring dates contracted through the service provider of the herein disclosed system. Artists that sign a contract with the system provider herein, agree to tour a specified period of time in the United States and the UK or other country. The tours include artists' lineups that link together similar artists further aiding to bring fans to the music and genre they enjoy and love. As such, musical artists and groups which would tour anyway, can now tour with other artists and reach a larger audience. Fans who are the users herein are thus given the opportunity to see multiple artist as well as discover new ones. This same system of organizing and paying the artists and groups can be employed for local venues such as bars and nightclubs, and small concert halls, as noted herein.

Further, such tours including concerts, festivals, or one time shows that users attend 24 provide advertisers with additional means to advertise, creating revenue 28. For example, PEPSI may be the only soda at festivals, as they pay a significant amount to advertise through the service as pop up or other ads. Further, artists can sell merchandise to the attending users to further increase revenue 26.

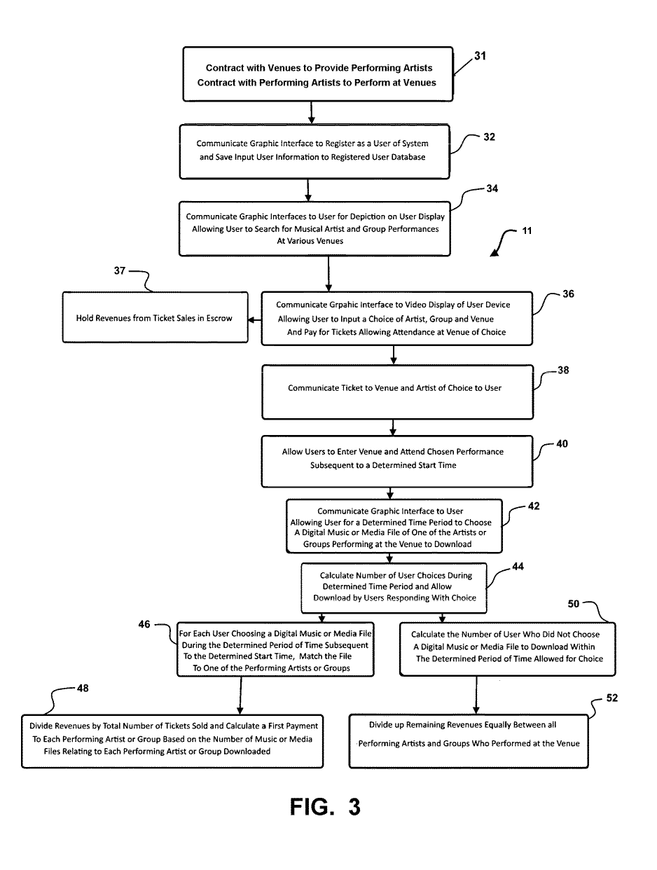

FIG. 3 depicts a particularly preferred mode of the system 11 herein, which is especially well configured to encourage the development of new artists and musical groups and to encourage the paying attendance of fans or users to venues where such groups and artists perform. In this mode of the system 11, the system provider will, in a first step, contact venue owners to provide artist performances in their venue at dates and times in the future 31. In a subsequent step tied to this first step, the system provider will reach agreement with artists such as musical artists or bands, to perform at each contracted venue 31.

In this mode of the system 11, as with other modes of the system 10 above, the system provider will communicate a graphic interface displayable on the display screen of the computing device of the user, to register each user 32 of the system 11. Thereafter, users will be allowed to log into the system 11 and graphic interfaces provided by the system 11 which are depicted on the video display of the device of the user, allow each user to search for artists and groups and venues for performances 34.

Users can, in a subsequent step, using a graphic interface communicated to their computing device and display screen, choose an artist or venue and pay for tickets 36 for an upcoming event. During the term between payment and the actual event, proceeds from such sales are held in escrow 37 for payment to the artists and performing groups. Deductions for profit and operating costs of the system 11 may be taken from the revenue in escrow 37.

Subsequent to payment, the system will communicate to each user purchasing such, a ticket to the chosen venue on the chosen date of the performances of the artist or musical group of choice 38.

On the date of the performance at any contracted venue where musical artists and groups have been contracted by the system provider to appear, users who have been issued a ticket will be granted access to the venue subsequent to a determined start time 40. This start time is determined in advance and thereafter used to calculate a subsequent step of calculating a maximum duration of a determined maximum time period. The determined maximum time period is a period of time subsequent to the determined start time 40, when users having tickets, may login to the system provider and choose a digital music or media file for download 42.

The chosen downloaded file must be directly related to one of the artists or musical groups performing at the venue and on the date of the performance, for which the user has purchased the ticket. For example it may be a recent musical album recorded by the artist or group who performed at the system provided venue on the date for the performance for which the user purchased the ticket.

In another preferred step of the system 11, ticket purchasing registered users will be communicated a graphic interface operating to allow users to download a chosen digital media or music file of the one performer of their choice 42, at any time from the moment they purchase the ticket, to the end of the determined time period. This determined time period begins at a determined start time for the concert or event at the venue, and ends upon the elapse of a determined time period. However, where the system provider wishes to ensure higher attendance at the provided venue by ticket purchasers, and allow for attendees who are not members, or in instances where the system provider wishes to encourage registered users to first attend the event before choosing, users will be communicated, upon request, a graphic interface allowing them to download a chosen digital media or music file of the performer of their choice 42, only at a time during the determined time which begins at the start time 40 of the event, and ends at after a determined time period.

Currently a preferred duration for the determined time period, is between 10 to 60 hours subsequent to the determined start time 40 at the venue. A particular favorite is for a time period equaling 48-hours subsequent to the determined start time 40.

This determined time period, such as the 48-hours, is to accommodate user schedules because it has in experimentation been determined to allow users time to get home and sleep, and make a reasoned decision on which digital media or music file, relating to which single artist or performing group, to download and have for playing on their system for enjoyment in the future. However, any duration determined by the system provider may be employed depending on other factors determined by the provider.

In a next step, the system provider, for the determined time period running subsequent to the start time, will calculate a responding percentage 44, from the total number of tickets sold to users 36. This responding percentage 44 is the percentage of users holding tickets, as part of the total tickets sold, who made a choice for download of a respective electronic digital music or media file, relating to a respective one of the artists or groups performing at the venue and on the date for which the user purchased a ticket.

In another step in the system, from the total number of electronic files requested for download by users, each artist or musical group performing at the venue on the day for which the users tickets were issued, will be matched with their respective artist percentage 46, from the responding percentage, based on downloaded media and music files which respectively relate to them, as the artist or musical group, to yield an artist percentage 46.

In a next step, from a percentage of the revenues equal to the responding percentage determined earlier which is multiplied by the artist percentage determined above, individual payments are calculated 48 to be paid from the revenues to each artist or musical group who performed at the venue on the date of the issued tickets to users. This is a most important step in this mode of the system 11 because pro rata share of the total revenues is tendered by the system provider to each artist and musical group who performed, based on a respective percentage of each respective artist or musical group had of the total media or music filed downloaded by users. Thus, the artist or musical group having a percentage of downloaded media or music files, is paid a higher amount from the revenues in this first payment.

In a next step, a non-responding percentage 50 of users is determined, which is the total number of users who purchased tickets, but who do not choose a digital media or music file to download, during the determined time period to do so.

In a final step, from the total revenues held in escrow 37, a percentage thereof equal to the non-responding percentage of users, is equally divided between all of the artists and preforming groups as a second payment 52.

As can be discerned, the artists and musical groups who perform best, or in a likeable manner such that they have a higher percentage of users downloading electronic media or music files relating to them, will receive a higher amount of payment in the first payment, and an equal amount as all other artists or groups in a second payment. This is especially preferred in the system to encourage known artists and up-and-coming artists to perform, since they will be paid extra for attracting the crowd.

Further, by getting more popular bands to draw crowds through extra payment, the system also ensures the artists or groups who are or become most popular and are a driver of fans and users to a venue, are paid more, but it also provides a second payment to all participating artists and groups for just performing by payment of the second payment. It will, thus, aid lesser known bands and groups to become known through larger crowds. Further, the system 11 also ensures that all artists and groups performing at all venues, are paid by the system provider, thereby allowing the artists to more freely travel and appear at a wide variety of venues in a large geographic area serviced by the system provider. This is because they may leave the venue as soon as finished and not wait for a calculation of payment and actual payment by the venue owner, since they are paid by the system provider automatically.

FIG. 4 depicts a mode of the system 11 similar to FIG. 3, where ticket sales revenue is paid to the performing artists based upon which digital music files are downloaded by attendees of the show or concert in a first payment 48 and in equal second payments 52. However, in the mode of the system 11 in FIG. 4, non user attendees are allowed to purchase and pay for tickets 33 to see the artist or musical group at a venue of choice and date of choice. Thereafter, tickets are communicated to the attendees 38, and ticketed attendees are allowed to enter the venue on the date of the event, subsequent to the start time 40.

In this mode of the system 11 of FIG. 4, attendees are communicated a graphic interface allowing them to join the system 11 and become users, 42 subsequent to either purchasing the tickets or attending the event. This mode of the system 11 thus allows attendees who are not yet members to purchase tickets, such as on the day of the event, and later register as users who subsequently have the right to choose to download a digital media or music file 42, during the determine time period subsequent to the start time.

Thereafter, the system 11 operates the same as that of FIG. 3, in that there are two payment streams to the performing artists and groups. A first payment to respective performing artists and performing groups is based on merit and the interest of users in downloading electronic files of their respective music. The second payment from the remainder of funds in escrow 37 is equally divided where an equal share in a payment amount of the remainder of revenues is paid to each respective participating performing artist or musical group.

Finally, as noted above, the system may easily be enabled to provide users a feature which will help connect users who play music, such as new bands, in finding fellow, like minded musicians. Using software configured to the task of maintaining a database of users who play music, and their type of instrument and locale and schedule, groups needing instrument players may be put in communication with users who play and users who play instruments not wanting a group can be put in communication with like minded users.

Additionally, musician users could upload samples of their instrument play, which would be associated with their profile and accessible to users searching for their type of instrument, musical likes, and geographic location. Thus, the system will allow musician users to get in contact with other musicians, listen to their music as a means to determine if the user musician is a fit for the band, and to arrange for a group session and perhaps form a musical band. Thus the system may be employed as a means of facilitating the formation of musical groups and music produced by such groups and for augmenting the musicians in formed groups.

The disclosed business method and service provided therein provides more income to artists, record companies, and advertisers. Further, fans are provided with a substantially beneficial experience simply by supporting their favorite artists and staying connected.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A system for selling tickets to users and attendees for a live performance of performing artists at venues, employing a network connected computing device having electronic memory for running computer software thereon, comprising the steps of:
from a network connected computing device of a system provider having electronic memory and running software running thereon configured to the task, communicating a graphic interface to computing devices of said users configured to the task of input of profile information of said users to become registered users;
storing respective said profile information of each registered user in electronic memory;
providing a performance venue;
providing a plurality of performers to provide a performance at said performance venue;
determining a start time for said performance where attendees are admitted into said performance venue;
communicating a graphic interface to said registered user operating to allow for a ticket purchase by said registered user to attend said performance at said performance venue;
holding the proceeds paid by said registered users for a total number of said ticket purchases for said performance at said performance venue, in escrow;
communicated a graphic interface to said registered users having made a said ticket purchase operating to allow said users to designate a chosen performer from said plurality of performers at said venue, and allow said registered user to download digital media of said chosen performer;
calculating a responding percentage of said proceeds by dividing a total number of said users who designate a chosen performer by said total number of said ticket purchases for said performance;
calculating a non responding percentage of said proceeds by subtracting said responding percentage of said proceeds from said proceeds;
from said responding precentage of said proceeds, paying each respective said performer from said plurality of performers, an artist percentage of said responding percentage of said proceeds, based on how many said users designate said performer as a said chosen performer; and
from said non responding percentage of said proceeds, paying an equal percentage thereof, to each respective performer from said plurality of performers.

2. The system of selling tickets of claim 1, additionally comprising the step of:
allowing said users to designate a chosen performer from said plurality of performers at said venue to allow said registered user to download digital media of said chosen performer only for a designated time period running between said starting time and a duration of time thereafter.

3. The system of selling tickets of claim 1, additionally comprising the step of:
allowing said users to designate a said chosen performer from said plurality of performers at said venue to allow said registered user to download digital media of said chosen performer, only for a designated time period running between said starting time and forty-eight hours thereafter.

4. The system of selling tickets of claim 2, additionally comprising the step of:
prior to said start time, allowing non registered users to purchase to make a said ticket purchase to attend said performance at said performance venue; and
during said designated time period, communicating said graphic interface to computing devices of said non registered user configured to the task of input of profile information of said non registered user to become registered users.

5. The system of selling tickets of claim 3, additionally comprising the step of:
prior to said start time, allowing non registered users to purchase to make a said ticket purchase to attend said performance at said performance venue; and
during said designated time period, communicating said graphic interface to computing devices of said non registered user configured to the task of input of profile information of said non registered user to become registered users.
